(19) United States
(12) Patent Application Publication
(10) Pub. No.: US 2011/0162527 A1
(43) Pub. Date: Jul. 7, 2011

(54) Microstructured Fibre Frit

(76) Inventors: Graham GIBSON, Kingston (CA); Junjie OU, Dalian (CN); Richard D. OLESCHUK, Kingston (CA)

(21) Appl. No.: 12/986,572

(22) Filed: Jan. 7, 2011

Related U.S. Application Data
(60) Provisional application No. 61/293,156, filed on Jan. 7, 2010.

(51) Int. Cl. B81B 1/00; C03C 11/00; B01D 15/08; B01D 53/02

(52) U.S. Cl. 96/101; 428/188; 428/398; 210/198.2; 428/99

(57) ABSTRACT

Provided is a frit having a body comprising a matrix material, and a plurality of microcapillaries formed within the matrix material, the microcapillaries substantially aligned with a longitudinal axis of the body. The frit may comprise a microstructured fibre, such as a photonic crystal fibre. The fit may be coupled to a fluidic conduit such as a chromatography column and/or a nanoelectrospray emitter. The frit may be used in applications such as solid phase extraction, electrospray ionization mass spectrometry, microreactor systems, and filtering particles in any fluid system where there is a need to retain particles.

### RELATED APPLICATION

This application claims the benefit of the filing date of U.S. Provisional Patent Application No. 61/293,156, filed on 7 Jan. 2010, the contents of which are incorporated herein by reference in their entirety.

### FIELD OF THE INVENTION

This invention provides a frit for use in applications such as chromatography columns, and methods therefor. In particular, the methods and apparatus described herein provide a micro structured fibre frit.

### BACKGROUND

A frit is a finely porous material, such as glass, through which gas or liquid may pass. Frits are used in laboratory glassware applications such as filters, scrubbers, spargers, resin beds for chemical synthesis, and packed chromatography columns. In the latter application, they retain packing material in the column while allowing gas or liquid to pass through. A frit is conventionally made by sintering together glass particles into a solid but porous body. However, there are problems with such frits in terms of manufacturing and reproducibility, factors that contribute to their relatively high cost.

Microscale bioseparations based on capillary or microfluidic chip formats offer advantages of miniaturization such as better separation efficiency, shorter analysis time, higher throughput and the possibility of system integration, such as coupling with mass spectrometry (MS). Among these techniques, capillary liquid chromatography (CLC), also called microcolumn LC (μLC), has been established as a complementary and/or competitive separation technique to conventional LC, facilitating widely important applications especially in the proteomics, pharmaceutical, or environmental fields. Further advantages of miniaturization include reduction of solvent waste and the small mass of stationary phase used. In addition, the relatively low flow rate of CLC is well suited for ESI-MS detection as it allows the entire mobile phase to be transferred to the MS instrument.

By far the most popular configuration of a capillary LC column is to have packed particulate retained by a fit. An ideal frit must not contribute to band broadening or affect peak shape while being robust enough to withstand the high pressures seen in CLC. Satisfying these conditions is difficult and the selection of an appropriate fit is important. Removable fits, much like those used in conventional HPLC columns, are useful and can be replaced if clogged. Such frits, however, are difficult to incorporate into small-bore capillaries of ≦100 μm i.d. and require specially designed coupling unions. Such fittings can add significant post-column dead volume and have other complications.

Typically, capillary column frits are prepared within the capillary itself. There has been much effort toward developing such frits for μLC or CEC. Early designs utilized silicate polymers or sol-gels based on organosilanes. Photo-initiated porous polymer monoliths have also been used as retaining frits, having the advantage of being able to be formed at any point within the capillary through the use of a photomask. Transient fits have even been fashioned from ferromagnetic particles held in place by a magnetic field. In all these cases, however, the frit material is fundamentally different from the packing material which can result in nonspecific adsorption and poor peak shape. In an attempt to make fits more like the packing material, fits are commonly prepared by sintering a small section of packed silica particles within the capillary using a heating filament. However, sintering disrupts the stationary phase in the frit region and the silica requires recoating. The sintering process must also be optimized for each particle type and size. Additionally, the heat applied removes the protective polyimide coating of the capillary, rendering the column fragile at the frit location.

Advances have been made in modifying the capillary column itself to retain particles, such as tapering it to a small i.d., but this technique is mostly useful for coupling the LC to ESI-MS. Other approaches, such as the formation of an obstruction such as a weir structure, are much less amenable to CLC than to microchip LC.

Strategies for fritless LC columns have been widely developed. One manifestation is that of macroporous monolithic columns, both polymeric and silica-based. The preparation and use of monoliths is significantly different than traditional packed particle columns, and perhaps as a result they have not been well adopted. Alternatively, conventional packed particles have been immobilized in an inorganic or polymeric matrix, or even thermally fused together, to obviate the need for a retaining frit, but for various reasons these approaches were not widely accepted.

### SUMMARY

Described herein is a frit, comprising: a body comprising a matrix material; and a plurality of microcapillaries formed within the matrix material, the microcapillaries substantially aligned with a longitudinal axis of the body. The microcapillaries may be arranged in a substantially parallel relationship within the body. The frit may comprise a microstructured fibre, such as a photonic crystal fibre. The fit may be coupled to a fluidic conduit. The fluidic conduit may comprise a chromatography column, a nanoelectrospray emitter, or both.

Also described herein is a module, comprising: the frit described above; and a solid support. The solid support may comprise a union. The solid support may comprise a capillary. The capillary may be a chromatography column. The solid support may comprise a chip substrate. The frit may be entirely embedded in the substrate. The frit may be partially embedded in the substrate such that one end of the frit protrudes from the substrate. The solid support may include a chromatography column coupled to the frit. The module may include at least one of a chromatography column coupled to the frit and a nanoelectrospray emitter coupled to the frit.

Also described herein is a fluidic conduit including the frit described above. The fluidic conduit may comprise at least one of a chromatography column and a nanoelectrospray emitter.

Also described herein is a method of preparing a frit, comprising: providing a body comprising a matrix material; wherein a plurality of microcapillaries are formed within the matrix material, the microcapillaries substantially aligned with a longitudinal axis of the body.

Also described herein is a method of preparing a module, comprising: providing a solid support; and disposing a frit as described herein in or on the solid support. The solid support may comprise a union, the method including disposing the fit in the union. The solid support may comprise a capillary, the method including coupling the fit to the capillary. The solid support may comprise a chromatography column, the method including coupling the frit to the chromatography column. The solid support may comprise a microfluidic chip substrate, the method including embedding the fit entirely in the substrate. The solid support may comprise a microfluidic chip substrate, the method including embedding the fit partially in the substrate, such that one end of the fit protrudes from the substrate. The solid support may include a chromatography column coupled to the frit and at least partially embedded in the microfluidic chip substrate. The end of the frit that protrudes from the substrate may be a nanoelectrospray emitter.

### BRIEF DESCRIPTION OF THE DRAWINGS

For a better understanding of the invention, and to show more clearly how it may be carried in effect, embodiments will be described below, by way of example, with reference to the accompanying drawings, wherein:

FIG. 1A is a plot showing back pressure as a function of flow rate for 4 cm lengths of microstructured fibres having 30, 54, 84, or 168 microcapillaries (3.8-5.6 μm internal diameters). FIGS. 1B and 1C show flow-induced back pressures at different flow rates from (FIG. 1B) various frits as indicated, and (FIG. 1C) packed columns with an integrated 54-hole MSF frit. In FIGS. 1B and 1C, frits were 1.0 cm long, the packed columns had 10.0 cm of packing material, and the mobile phase was 50% ACN/water (v/v).

FIG. 2A is a photograph of a packed chromatography column coupled to a fit using PicoClear™ union, as described herein. FIG. 2B is a photomicrograph of the junction of the chromatography column and the frit of FIG. 2A.

FIG. 3 is a plot showing detection of ibuprofen with a UV detector (Waters Acquity UPLC TUV) using the chromatography column depicted in FIG. 2A and a NanoAcquity UPLC system. The plot shows the relative insensitivity of band broadening, as measured by plate number, to MSF fit length.

FIG. 4 is a photograph of a microfluidic chip including a chromatography column and a MSF frit partially embedded in the substrate of the chip.

FIG. 5 is a plot showing complete separation of the peptides bradykinin and leucine enkephalin by mass spectrometry, obtained using a microfluidic chip chromatography column with an integrated frit and electrospray emitter as described herein.

FIG. 6 is a photomicrograph of a 1 mm MSF frit having 54 microcapillaries embedded in a microfluidic chip.

FIGS. 7A-7C are optical microscope images of MSF frits embedded in a wide bore capillary. (FIG. 7A) MSF frit with 54 microcapillaries in a wide bore capillary; (FIG. 7B) MSF frit with 168 microcapillaries in a wide bore capillary; (FIG. 7C) MSF frit with 168 microcapillaries in a wide bore capillary containing an embedded narrow bore capillary (with outer polyimide layer removed) coupled with the frit.

FIG. 8 shows separation of an EPA 610 PAH mixture on an ODS-packed capillary column with an integrated 168-capillary MSF as the frit. The column was 10 cm long×250 μm I.D. packed with Microsorb ODS 3-μm particles; a 2 μL sample (in 45% ACN, 45% water, 5% MeOH, 5% CH₂Cl₂ v/v/v/v) was injected, followed by gradient elution 50-100% ACN in 40 min at 2.5 μL/min; detection was by UV absorption at 254 nm.

FIGS. 9A and 9B show separation of an analgesic drug mixture on an ODS-packed capillary column with an integrated 168-capillary MSF frit. The analytes were acetaminophen (1), acetylsalicylic acid (2), ketoprophen (3), naproxen (4), nabumetone (5) and ibuprofen (6). The column was 10 cm long×250 μm I.D. packed with Microsorb ODS 3-μm particles; a 2 μL sample (2-10 μM in 5% acetonitrile/water) was injected, followed by (FIG. 9A) gradient elution 10-70% ACN in 15 min or (FIG. 9B) 10-30% ACN in 2 min, then 30-40% ACN in 18 min, then 40-60% ACN in 10 min at 2.5 μL/min; detection was by UV absorption at 214 nm.

### DETAILED DESCRIPTION OF EMBODIMENTS

Described herein is a frit including a plurality of separate, distinct microcapillaries passing therethrough. The frit is suitable for use in applications such as, but not limited to, chromatography (such as liquid chromatography (LC), gas chromatography, or supercritical fluid chromatography), solid phase extraction (SPE), electrospray ionization mass spectrometry (ESI-MS), microreactor systems, and filtering particles in any fluid system where there is a need to retain particles, wherein the particles can be non-living matter, which may include solids and semi-solids, including macromolecules, (e.g. polymers, proteins, DNA) or living matter (e.g., cells, bacteria), or viruses, or parts or combinations thereof. A frit as described herein is also suitable for lab-on-a-chip systems with integrated separation channels, used for small-scale separations such as in protein analysis. When coupled to a packed chromatography column, the frit retains the packing material (e.g., particulate matter in any retainable size or shape or combination thereof, e.g., spheres, which may or may not be reagent-laden) in the column while allowing liquid or gas to pass through, without generating substantial back pressure.

In one embodiment, the frit is made of a matrix material, and has a plurality of microcapillaries formed through the matrix material. In such an embodiment, the microcapillaries form a plurality of holes or pores running through the length (i.e., non-tortuously along the longitudinal axis) of the frit. Although not essential, the microcapillaries may be arranged in a substantially parallel relationship. The matrix material may be of a substantially uniform material such as, for example, a silica-based material like glass, or a polymeric material such as a plastic, such that there is matrix material and no air space between microcapillaries.

The number of microcapillaries in the fit may range from 3 to 10,000, from 3 to 1000, or from 3 to 100. The inside diameters of the microcapillaries may be the same or different and may be from 50 nm to 50 μm, from 500 nm to 10 μm, or from 1 μm to 8 μm, for example, 4 μm to 5 μm. A frit may be prepared with a number of microcapillaries and microcapillary diameter selected for a given application, as these factors are related to the amount of back pressure that is introduced by the frit, the flow rate through the frit, etc. The inside diameter of the microcapillaries may be larger, the same size, or smaller than the particle size of the packing material of a chromatography column. In embodiments where the inside diameter of the microcapillaries is larger than the particle size, the keystone effect allows the particles to be trapped in the microcapillaries without significant amounts entering the microcapillaries. The length of the frit is selected for a given application. For example, for chromatographic applications, the frit should be as short as possible to minimize band broadening due to diffusion within the dead volume of the frit. However, if the frit is itself functional, the length will be dictated by that function, or if the local dilution of compounds is not important (e.g., for a microreactor bed), the frit length is less critical. Generally, the frit should be as short as possible to withstand an applied pressure drop across the frit.

In one embodiment, the fit is made from a microstructured fibre (MSF). An example of a MSF that is commercially available is a photonic crystal fibre (PCF). PCFs are commonly used for guiding light in optical applications. A PCF is essentially an optical fibre (usually made of silica and having an outer coating made of an acrylate-based polymer and a cladding having a plurality of microscopic capillaries (i.e., microcapillaries) running along the entire length of the fibre. In optical applications, light is confined to either a solid or hollow core through periodic refractive index changes. The refractive index changes are developed through the microcapillaries that run throughout the length of the fibre. In optical applications PCFs have superior performance relative to conventional optical fibres, mainly because they permit low loss guidance of light in the core (see Russell, P., Science 2003, 299, 358-362). PCFs have also been used in various non-optical applications, including microchip electrophoresis (Sun, Y., et al., Electrophoreses 2007, 28, 4765-4768); however, none of those applications relates to a frit. The inventors believe that they are the first to prepare a frit from a PCF. Use of a MSF as a frit as described herein for chromatography applications renders the frit/chromatography column interface visible, which may be advantageous in some situations.

As an example, a MSF of ˜230 μm diameter with an array of 168 4-5 μm microcapillaries and 6-7 μm between channels (LMA-20 from NKT Photonics, Denmark) was coupled to a chromatography column integrated into a lab-on-a-chip system, and retained 3 μm MicroSorb C18 microspheres (Varian, Inc., Palo Alto, Calif.) or 3.5 μm Zorbax C8 microspheres (Agilent Technologies, Inc., Santa Clara, Calif.) packed into the column of the chip. Initial packing of the column may be carried out using any suitable technique. For example, a HPLC pump with the packing loop attached may be used. If tighter packing is desired, a sonicator may be used after initial packing. The column may be immersed in the sonicator as required to achieve the desired tighter packing.

When coupled to a chromatography column, each microcapillary of a frit as described herein conducts liquid or gas exiting the column. Coupling to a chromatography column may be achieved using a union capable of withstanding the pressure applied to fluids in the column (e.g., up to 8,000 p.s.i.g., or greater). For example, a PicoClear™ union, available from New Objective, Inc. (Woburn, Mass.) may be used. Alternatively, a MSF fit as described herein may be coupled to a chromatography column by inserting the frit directly into the chromatography column, and securing it in place using a suitable technique such as, for example, bonding with a polymer. Such an embodiment is described in the Working Examples.

Frits prepared from glass MSF may be modified to alter sample adsorption characteristics. For example, surface modification (e.g., silanization) may be desirable to prevent adsorption in certain chromatography applications, whereas modification to enhance sample adsorption may be desirable in applications such as filtering or extraction. Modification may employ one or more chemical moieties, such as, for example, chloromethylsilane or trimethoxy-based acrylate (Gottschlich, et al., Anal. Chem. 2001, 73, 2669-2674). Surface modification may also include treatment with compounds of the type such as, for example, C(OR)₄ (orthocarbonates), R′C(OR)₃ (orthoesters), and R′R″C(OR)₂ (acetals and ketals). For R′C(OR)₃ compounds, examples of R′ include, but are not limited to H, Me, Et, Bu, Pr, and Ph, and examples of R include, but are not limited to, Me, Et, Bu, and Ph. For R′R″C(OR)₂ compounds, examples of R′ include, but are not limited to, H and Me, and examples of R″ include, but are not limited to, H, Me, CH₂CN, CH₂COMe, and p-C₆H₄COH, where R is Me or Et. For further details, see Guidotti, et al., J. Colloid Interface Sci. 1997, 191, 209-215. Other functionalizing agents may of course be used, as required for specific applications. It should be noted that a MSF fit as described herein, with or without modification, may be used for other applications, including but not limited to liquid chromatography (LC), solid phase extraction (SPE), electrospray ionization mass spectrometry (ESI-MS), microreactor systems, and filtering particles. MSF frits are particularly well-suited to filtering applications because of the ability to accurately and reproducibly control microcapillary size (i.e., diameter) during fabrication.

Also described herein is a module including a frit and a solid support. In one embodiment the solid support is a union, which allows the fit to be easily coupled to a fluidic conduit, chromatography column, or other equipment or system such as, for example, a LC, SPE, ESI-MS, or microreactor system. In another embodiment the module includes a chromatography column or a fluidic conduit as the solid support, to which the frit is secured or bonded in a manner which allows passage of fluid from the column or conduit to the frit. The fluidic conduit of this embodiment may be coupled to other equipment or system such as, for example, a LC, SPE, ESI-MS, or microreactor system.

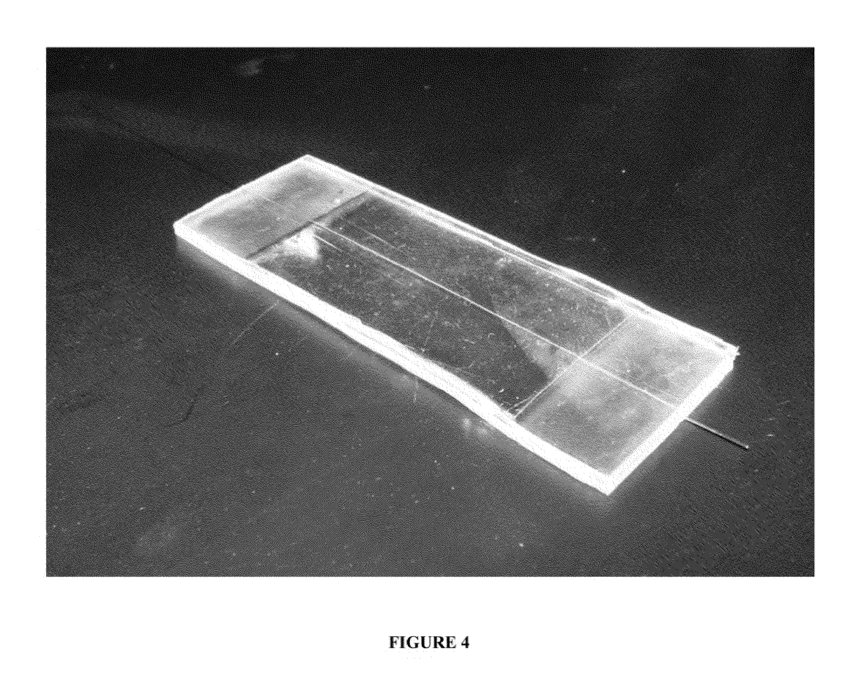

In another embodiment the module includes a chip substrate (e.g., a microfluidic chip) as the solid support. In one example of this embodiment the frit is partially embedded into the substrate, such that one end of the frit protrudes from the chip and the other end is embedded in the substrate and coupled to a chromatography column or other device or fluidic conduit also embedded in the substrate (see FIG. 4). The protruding end of the frit may be used as a nanoelectrospray emitter (e.g., for mass spectrometry), or coupled to other fluidic conduit, equipment, or system such as, for example, a LC, SPE, or microreactor system. In another alternative of this embodiment the fit is completely embedded into the substrate, such that both ends of the frit are coupled to chromatography columns or other devices at least partially embedded in or secured to the substrate.

Robustness of in-column immobilized MSF fits was tested by flowing 95% acetonitrile/water through the assembled 250 μm I.D. column. The flow rate was increased by 50 μL/min increments while monitoring back pressure until the frit failed. For a 5 mm-long 54-hole MSF, it was found that the frit failed when the pressure reached 78 bar at a flow rate of 500 μL/min, while the same MSF at 10 mm long was still stable when the pressure reached 200 bar. In comparison, a 10 mm-long porous polymer monolith (PPM) frit in a capillary with 100 μm I.D. failed when the pressure reached 90 bar.

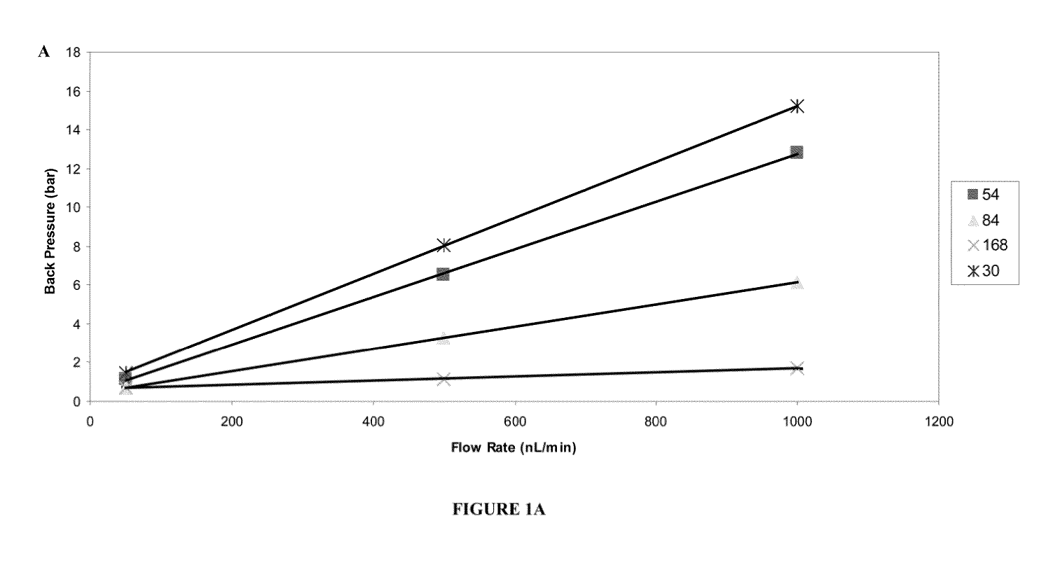

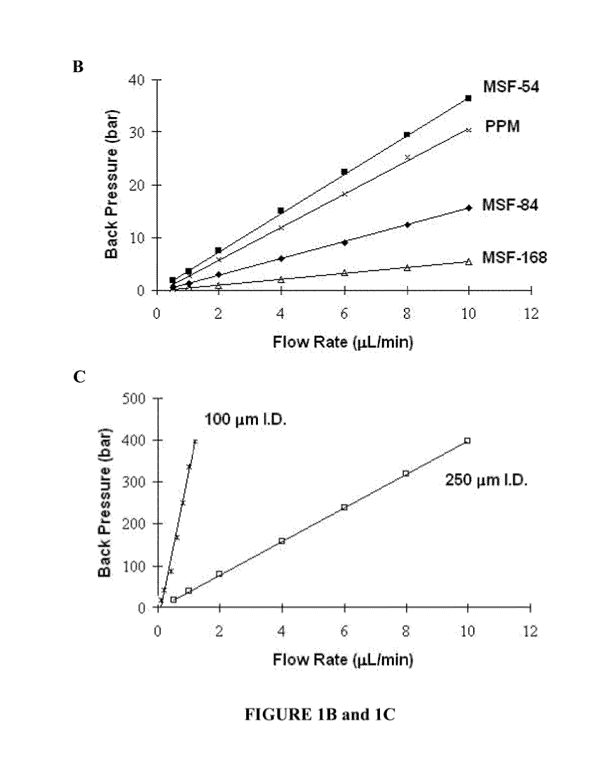

Permeability of MSF and PPM fits was investigated by measuring the back pressure at various flow rates of 50% water/ACN mobile phase. Back pressure scales linearly with flow rate and frit length, so plots like these may be extrapolated to a wide range of conditions. The back pressure results for PPM and three MSF types are presented in FIG. 1B. As expected, back pressure decreases as the number of capillaries (or total capillary cross-sectional area) increases. The highest back pressure is 36.4 bar for a 54-capillary MSF frit at a flow rate of 10 μL/min, while the back pressure is 15.7 and 5.4 bar for the MSF frits with 84 and 168 capillaries, respectively, under the same conditions. The back pressure of a PPM frit in a 100 μm I.D. capillary reached 30.5 bar at a flow rate of 10 μL/min, only slightly less than that of MSF with 54 capillaries, which has open channels in only 75 μm of its face (see Table 1).

TABLE 1
Characteristics of MSF Frits.

| | | | Diameter of | O.D. | O.D. |
|---|---|---|---|---|---|
| | Capillary | Capillary | capillary | without | with |
| Number of | diameter | Area | region | coating | coating |
| capillaries | (μm) | (μm²) | (μm) | (μm) | (μm) |
| 54 | 3.8 | 612 | 75 | 230 ± 3 | 330 ± 10 |
| 84 | 4.3 | 1220 | 92 | 230 ± 5 | 405 ± 10 |
| 168 | 5.6 | 4138 | 185 | 230 ± 3 | 350 ± 10 |

Durability of MSF-based frits was tested after packing with ˜10 cm of 3 μm ODS beads. FIG. 1C indicates the back pressure of the capillary columns with a 54-capillary MSF frit at various flow rates of 50% water/ACN mobile phase. The columns proved stable up to 400 bar (before the experiment was stopped due to the pressure rating of the fittings), satisfying pressure requirements for most capillary LC experiments. The 250 μm I.D. capillary column reached 400 bar at a flow rate of 10 μL/min, indicating good stability at high flow rates and the ability to perform as a frit for CLC over a wide range of conditions.

The longevity of a MSF fritted column as described herein was evaluated using the retention factor and column efficiency obtained by the separation of the four alkylbenzenes. After several tens of runs, the retention factors of all analytes showed little change for any of the integrated MSF frit types. This result indicates that the frit remains stable over a long period of use. Furthermore, no loss of packing material or change in column back pressure was observed despite the fact that the channels in a MSF are larger than the diameter of the packing material particles. This result can be attributed to the “keystone effect” whereby the force of particles pushing each other against the wall provides sufficient friction to keep them in place, perhaps more accurately described as a “log jam”. In contrast, porous polymer monolith (PPM)-fritted columns exhibit significant loss of column efficiency after several weeks. Such loss in efficiency is presumably due to the swelling/shrinking behaviour of polymer monoliths and the probable formation of larger open channels bypassing the bulk monolith.

Column-to-column reproducibility was also studied using alkylbenzene chromatography. For three integrated MSF-fritted columns prepared as described herein, retention factors of four analytes showed relative standard deviations (RSDs) of less than 3%. This result indicates that columns with MSF frits can be fabricated with satisfactory reproducibility.

As noted above, a frit as described herein may also be used as a nanoelectrospray emitter (e.g., for mass spectrometry), if the end of the MSF from which the sample exits, after passing through the fit, is of a suitable length to perform as an emitter. Such an emitter and frit combination may be constructed in a microfluidic chip, as described above and in Example 5, below, or from a MSF without a microfluidic chip. Further, in either case the emitter and frit combination may optionally also include a chromatography column.

In general, a frit as exemplified by the embodiments described herein is easily produced, has high reproducibility, is inexpensive, long lasting, able to resist clogging, and has low back pressure relative to a conventional frit (e.g., made from sintered glass particles). Further, a frit as described herein provides the ability to specifically tailor the permeability (i.e., microcapillary spacing and size) for a given application.

Embodiments will be further described by way of the following non-limiting examples.

### Working Examples

### 1. Chemicals and Materials

Microstructured fibres (containing 30, 54, 84, and 168 holes) were purchased from Crystal Fibre (NKT Photonics) (Denmark). Polyimide-coated fused-silica capillaries with 100 μm I.D.×360 μm O.D., 250 μm I.D.×360 μm O.D. and 100 μm I.D.×245 μm O.D., as well as UV-transparent PTFE-coated fused-silica capillary with 100 μm I.D.×360 μm O.D. were obtained from Polymicro Technologies (Phoenix, Ariz., USA). A PicoClear™ union (PCU-360) was purchased from New Objective Inc. (Woburn, Mass., USA). All chemicals were used directly without further purification unless otherwise stated. Sylgard 184 PDMS prepolymer base and curing agent were purchased from Dow Corning (Midland, Mich., USA). Butyl acrylate, 1,3-butanediol diacrylate, benzoin methyl ether (BME) and [γ-(methacryloyloxy)propyl] trimethoxysilane (γ-MAPS) were all purchased from Aldrich (Oakville, Canada). HPLC-grade acetonitrile (ACN) and reagent-grade methanol were from Fisher Scientific, while formic acid (98%) was from BDH Chemicals (Toronto, Canada). Ethanol (95%) was purchased from Commercial Alcohols (Brampton, Canada). EPA 610 polycyclic aromatic hydrocarbons (PAH) mixture was obtained from Sigma-Aldrich (Oakville, Canada). Octadecylsilane (ODS)-functionalized silica particles with 100 Å pores (Microsorb 100-3 μm) were from Varian (Mississauga, ON, Canada). Water used in all experiments was purified by a Milli-Q system (Millipore Inc., Milford, Mass., USA).

### 2. Instrumentation and Methods

μLC experiments were performed on a Waters NanoAcquity™ UPLC system equipped with a tunable UV detector and a 2-μL sample loop. Data was acquired with MassLynx software (v4.1). Packed capillary columns were connected to the pump using a zero-dead-volume MicroTight® PEEK union and fittings from Upchurch Scientific (IDEX, Oak Harbor, Wash., USA), while the column end was coupled inline with the detector using a transparent Teflon® sleeve union. Sample solutions were prepared in 10-40% acetonitrile/water solution (v/v) for different samples with concentrations of 5-20 ng/mL. The injection volume was 2 μL, and the detector was set at 254 nm for PAH compounds or 214 nm for other analytes. Experiments were performed at ambient temperature. Both isocratic and gradient methods were used as indicated, with mobile phases consisting of A) 99.9% water with 0.1% formic acid and B) 99.9% acetonitrile with 0.1% formic acid.

### 3. Investigation of Back Pressure of MSF Frits

Frits were prepared from microstructured fibres having 30, 54, 84, or 168 microcapillaries (3.8-5.6 μm internal diameters). Back pressure of 4 cm lengths of each fibre was measured using an Eksigent nanopump with 50% ACN/H₂O at several flow rates. The plot of FIG. 1 was obtained. From the slopes, the back pressure (in bar) for each frit was calculated to be 14.7±0.2, 12.3±0.6, 5.7±0.4, and 1.1±0.3, respectively, for 1 μL/min flow rate. These results suggest that the MSF frits can exhibit lower back pressure than monolithic frits typically used in chromatography applications.

Alternatively, back pressure of fits was measured with an Waters NanoAcquity™ UPLC pump (Milford, Mass., USA). Columns were flushed for at least 30 min with the mobile phase (ACN/water, 50/50, v/v) before measuring back pressure. Measurements were taken twice at each of 7 flow rates between 0.5 and 10 μL/min.

### 4. Chromatography Column Efficiencies with MSF Frits

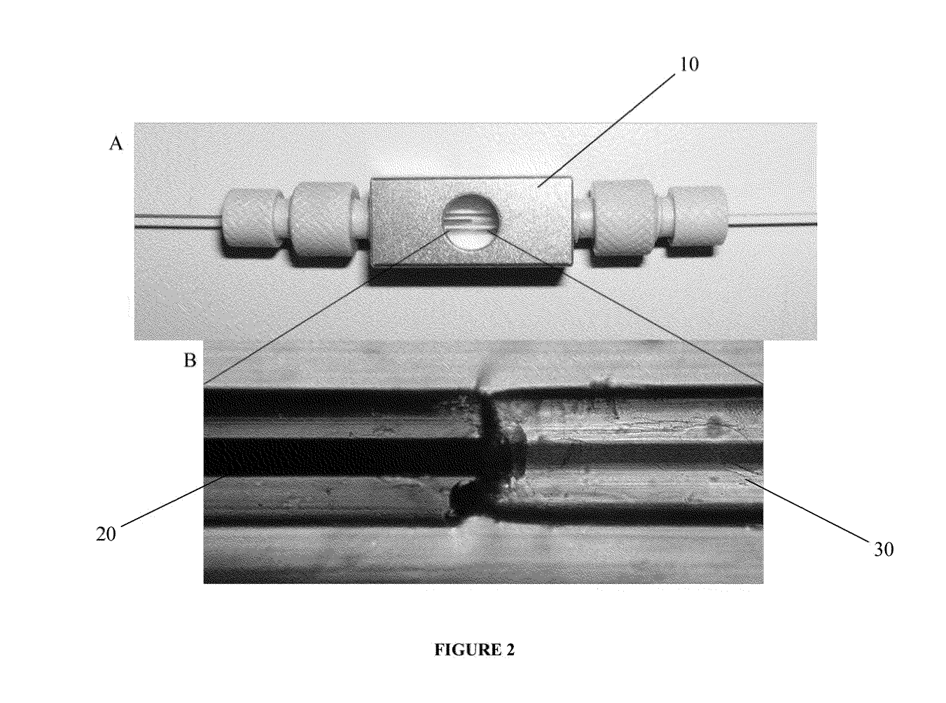

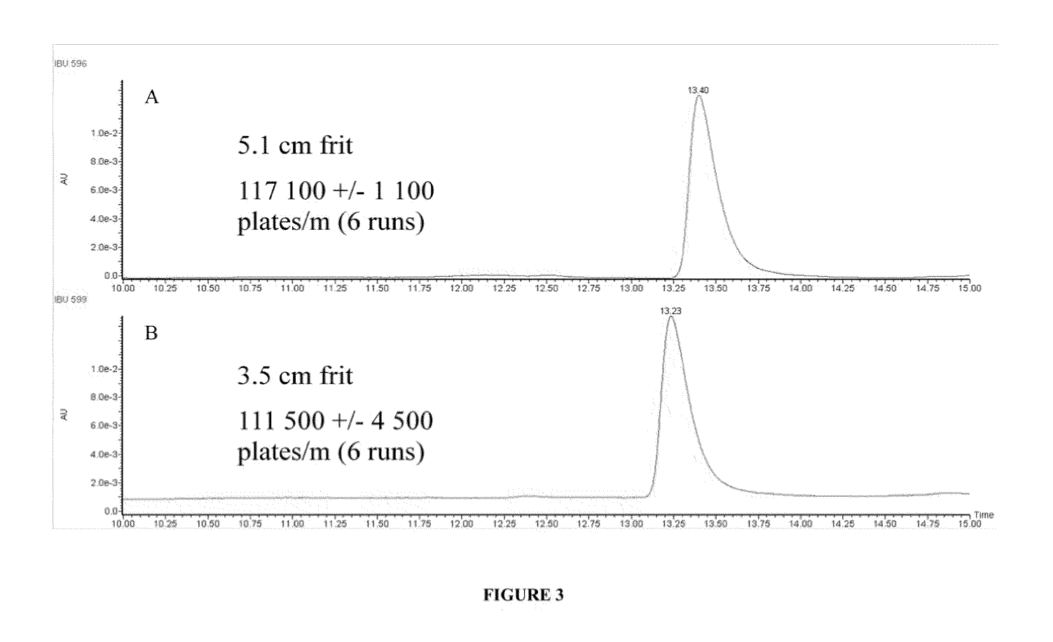

Microstructured fibre frits were used with chromatography columns. The columns were prepared in-house and measured 75 μm inner diameter (i.d.)×11.15 cm long and were packed with 3 μm MicroSorb C18 microspheres. The columns were coupled to 54 microcapillary frits (5.1 cm or 3.5 cm) using a PicoClear union (New Objective, Inc., Woburn, Mass.). An example is shown in FIG. 2A, wherein the packed column 20 and frit 30 are coupled with the union 10. FIG. 2B is a photomicrograph showing a close-up of the chromatography union and the frit. FIGS. 3A and 3B show isocratic elution of ibuprofen from the column with 50% ACN using the 5.1 cm frit and the 3.5 cm frit, respectively, with resulting column efficiencies as indicated.

### 5. Microfluidic Chip for Liquid Chromatography Employing a MSF Frit

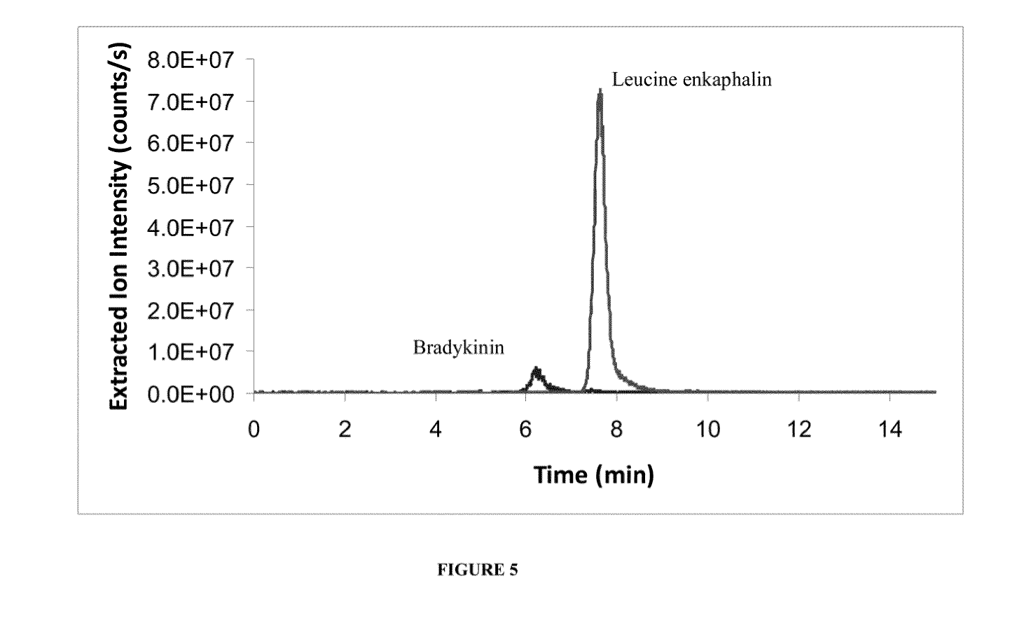

MSF frits were also used with microfluidic chips for liquid chromatography and mass spectrometry. Microfluidic chips having embedded chromatography columns were coupled to 54 microcapillary frits. The columns were formed from an enclosed channel within the plastic chip substrate. The channels had a semi-circular cross section (formed by pressing a 360 or 150 μm capillary into the plastic under heat and pressure, removing it, then closing the channel with a flat cover plate; see Example 4). The resulting columns were 360 or 150 μm in diameter, 3.5 to 11.5 cm long. A typical chip is shown in FIG. 4, with the MSF fit protruding from the end of the chip. The protruding end of the fit conveniently was used as an electrospray emitter for mass spectrometry, allowing direct coupling with a MS detector). The columns were packed with 3.5 μm Zorbax C8 beads using a Waters 590 HPLC pump, with a packing loop attached. After initial packing, the chips were immersed in a sonicator and packed more tightly for 15 min. A mixture of the peptides bradykinin and leucine enkephalin was isocratically eluted with 20% CH₃CN (0.1% HCO₂H) at 300 nL/min (1.5 pmol injected). Complete separation of the peptides was obtained, as shown in FIG. 5.

### 6. MSF Frit Embedded in Plastic Substrate of a Microfluidic Chip

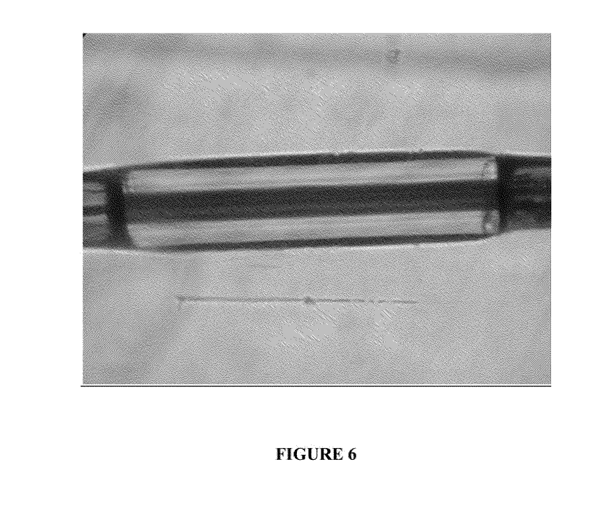

A substrate for a microfluidic chip was prepared from two pieces of cyclic olefin copolymer (COC) about 2.5×7.5 cm and 2 mm thick. A channel was created in the first piece of COC by pressing a length of 150 μm outer diameter (o.d.) capillary (with polyimide coating) into the COC material at 143° C. and 2000 N force for 10 min. The acrylate coating of a small length of MSF (e.g., 54 microcapillary MSF) was removed by soaking in toluene for ˜2 min. The resulting MSF was about 230 μm in diameter and was cut using a ceramic hand-scoring tool to 1 mm in length. The MSF was placed in the channel, and a 150 μm o.d.×75 μm i.d. capillary was placed in the channel at each end of the MSF as inlet and outlet tubing. The second piece of COC was thermally bonded to the first piece at 133° C. and 2500 N force for 10 min to enclose the channel and capture the capillaries and the frit, as shown in FIG. 6. Further stamping was done at the inlet and outlet with the aid of toluene to prevent leaks from around the inlet and outlet tubing. The resulting chip was packed with 3.5 μm C8 Zorbax beads (Agilent Technologies) to 3.9 cm without any observed leaking around the fit.

### 7. Preparation of MSF-Fritted Capillaries

Two methods were developed to prepare MSF-fritted capillaries. First, a MSF was cut to a 5 cm length using a fibre cleaver (FiTel, Furukawa Electric, Japan). A commercial PicoClear™ union, providing a visible zero-dead-volume connection rated to >275 bar, was used to connect a capillary 20 cm long with 100 μm I.D.×360 μm O.D. and a length of MSF. The resulting column could be directly packed with ODS-functionalized silica beads, leaving a MSF as the column end, which shares the same O.D. as a conventional capillary. Thus, the MSF end may be further coupled inline to ESI-MS or to other instrument such as a UV detector.

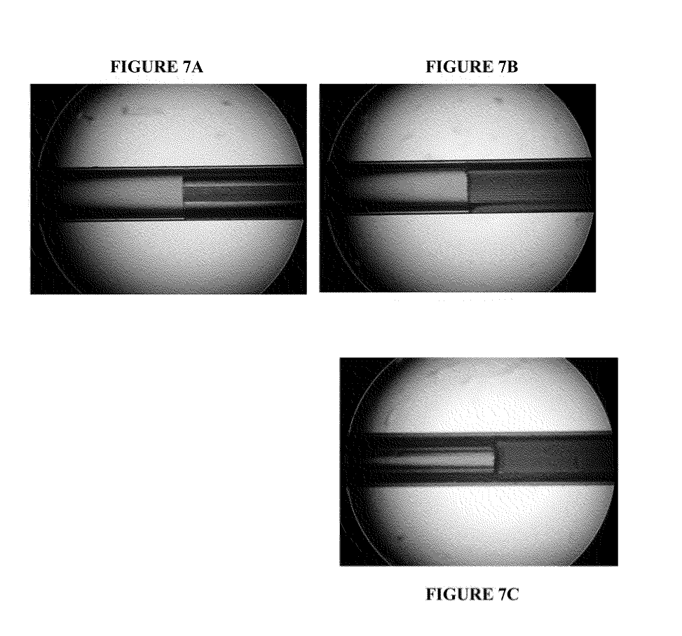

In the second method, the MSF was incorporated into the end of a capillary. The acrylate coating of a 2 cm length of MSF was removed after swelling by immersion in toluene for 10 min (other solvents such as acetone or acetonitrile may also be used). The resulting MSF was painted with a layer of polydimethylsiloxane (PDMS) prepolymer, prepared by mixing Sylgard 184 PDMS prepolymer base and curing agent (Dow Corning, Midland, Mich., USA) at a weight ratio of 10 to 1. The painted MSF was then carefully inserted 1 cm into a wide bore capillary (250 μm i.d.×363 μm o.d., 20 cm in length), leaving 1 cm of fibre exposed. The PDMS prepolymer was cured in an oven at 80° C. for 1 h. Following curing, the 1 cm exposed fibre was cut off, leaving a 1 cm frit embedded in the end of the wide bore capillary. Wide bore capillaries with the inserted 54 and 168 microcapillary MSF frits are shown in FIGS. 7A and B.

To modify the columns for packing beads, a narrow bore capillary (100 μm i.d.×245 μm o.d.) was inserted into the end of the wide bore capillary opposite the MSF frit. First, the outer polyimide coating layer was removed from a 20 cm length of the narrow bore capillary by burning with a flame. The same PDMS prepolymer was painted onto the outside of the narrow bore capillary and it was carefully inserted into the wide bore capillary, leaving 1 cm exposed. After curing under the same conditions and removing the excess capillary, both narrow bore capillary and MSF frit were immobilized in the wide bore capillary, giving an encased capillary column equivalent in dimensions to a commercially available capillary column, as shown in FIG. 7C.

### 8. Packing MSF-Fritted Capillary Columns

Capillary columns were prepared by packing ODS-functionalized silica beads (3 μm) with a slurry-packing technique. A slurry was first prepared by mixing the ODS beads with acetonitrile (5 mg/mL) and sonicating for 30 min to thoroughly wet their surface and prevent agglomeration. The slurry was immediately packed into the capillary using flow from a HPLC pump at ˜275 bar. The effective length of packed stationary phase was about 10 cm. Prior to chromatography, each column was flushed with the starting mobile phase.

### 9. Applications of MSF-Fritted Columns

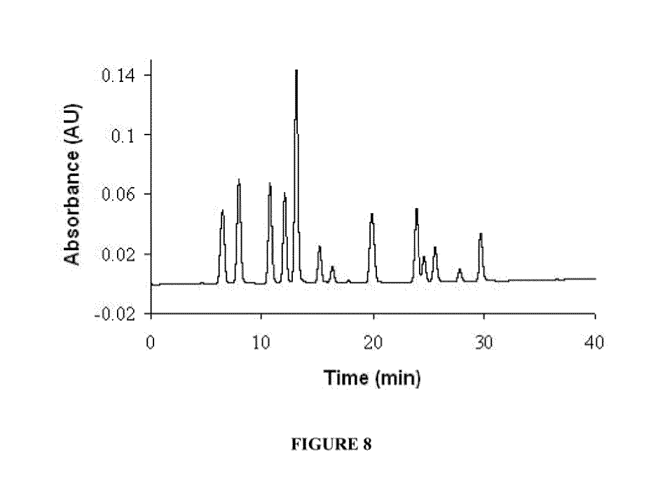

To demonstrate the favorable characteristics of packed capillary columns using MSFs as fits, a commercially available mixture of 16 PAHs (EPA 610) was separated on a 10.0 cm×250 μm I.D. packed column with an integrated 168-hole MSF frit using gradient elution. The resulting chromatogram is presented in FIG. 8. The PAH elution order is as expected for a conventional reversed-phase HPLC separation, and 15 peaks may be observed. One compound was not resolved or not detected. Overall, the result indicates that a column with an integrated MSF frit is capable of separating a complex mixture of similar analytes.

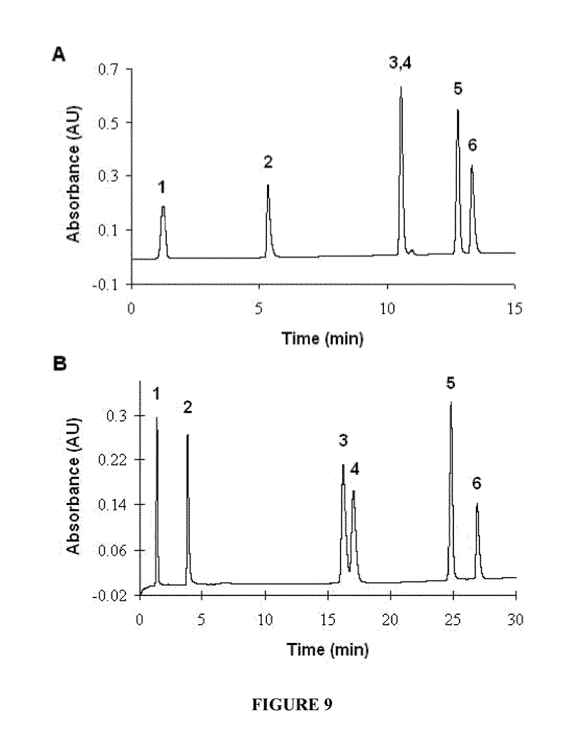

As an alternative application, the separation of various analgesic drugs (acetaminophen, acetylsalicylic acid, ketoprophen, naproxen, nabumetone, and ibuprofen) was also carried out. Presented in FIG. 9A is a typical chromatogram showing separation of 5 of the 6 drugs using a linear gradient from 10 to 70% B in 15 min at a flow rate of 2.5 μL/min. While ketoprophen and naproxen are not resolved using this method, they are separated with an optimized method, as shown in FIG. 9B. The result shows that a MSF frit does not impede chromatographic performance of the column and that the column can be handled in the same manner as a conventional capillary LC column. The result also demonstrates that a MSF frit is suitable for use in separation of hydrophilic components.

All cited publications are incorporated herein by reference in their entirety.

### EQUIVALENTS

While the invention has been described with respect to illustrative embodiments thereof, it will be understood that various changes may be made to the embodiments without departing from the scope of the invention. Accordingly, the described embodiments are to be considered merely exemplary and the invention is not to be limited thereby.

1. A frit, comprising:
a body comprising a matrix material; and
a plurality of microcapillaries formed within the matrix material, the microcapillaries substantially aligned with a longitudinal axis of the body.

2. The frit of claim 1, wherein the microcapillaries are arranged in a substantially parallel relationship within the body.

3. The frit of claim 1, comprising a microstructured fibre.

4. The frit of claim 3, wherein the microstructured fibre comprises a photonic crystal fibre.

5. The frit of claim 1 coupled to a fluidic conduit.

6. The frit of claim 5, wherein the fluidic conduit comprises a chromatography column, a nanoelectrospray emitter, or both.

7. The frit of claim 6, wherein the chromatography column is for liquid chromatography.

8. The frit of claim 6, wherein the chromatography column is for gas chromatography.

9. A module, comprising:
the frit of claim 1; and
a solid support.

10. The module of claim 9, wherein the solid support comprises a union.

11. The module of claim 9, wherein the solid support comprises a capillary.

12. The module of claim 11, wherein the capillary comprises a chromatography column.

13. The module of claim 9, wherein the solid support comprises a chip substrate.

14. The module of claim 13, wherein the frit is entirely embedded in the substrate.

15. The module of claim 13, wherein the frit is partially embedded in the substrate such that one end of the frit protrudes from the substrate.

16. The module of claim 9, wherein the module includes at least one of a chromatography column coupled to the fit and a nanoelectrospray emitter coupled to the fit.

17. A fluidic conduit including the frit of claim 1.

18. The fluidic conduit of claim 17, comprising at least one of a chromatography column and a nanoelectrospray emitter.

19. A method of preparing a fit, comprising:
providing a body comprising a matrix material;
wherein a plurality of microcapillaries are formed within the matrix material, the microcapillaries substantially aligned with a longitudinal axis of the body.

20. A method of preparing a module, comprising:
providing a solid support; and
disposing the frit of claim 1 in or on the solid support.

21. The method of claim 20, wherein the solid support comprises a union, including disposing the frit in the union.

22. The method of claim 20, wherein the solid support comprises a capillary, including coupling the fit to the capillary.

23. The method of claim 20, wherein the solid support comprises a chromatography column, including coupling the frit to the chromatography column.

24. The method of claim 20, wherein the solid support comprises a microfluidic chip substrate, including embedding the frit entirely in the substrate.

25. The method of claim 20, wherein the solid support comprises a microfluidic chip substrate, including embedding the fit partially in the substrate, such that one end of the frit protrudes from the substrate.

26. The method of claim 24, wherein the solid support includes a chromatography column coupled to the frit and at least partially embedded in the microfluidic chip substrate.

27. The method of claim 25, wherein the solid support includes a chromatography column coupled to the frit and at least partially embedded in the microfluidic chip substrate.

28. The method of claim 25, wherein the end of the frit that protrudes from the substrate is a nanoelectrospray emitter.
